(19) United States
(12) Patent Application Publication
(10) Pub. No.: US 2019/0139730 A1
(43) Pub. Date: May 9, 2019

(54) Colored Circuit Breaker System

(71) Applicant: Brian Schofield, Huntley, IL (US)

(72) Inventor: Brian Schofield, Huntley, IL (US)

(21) Appl. No.: 16/182,528

(22) Filed: Nov. 6, 2018

Related U.S. Application Data
(60) Provisional application No. 62/582,663, filed on Nov. 7, 2017.

(51) Int. Cl. H01H 71/06; H02B 1/20; H01H 71/02

(52) U.S. Cl. CPC H01H 71/06; H02B 1/20; H01B 7/361; H01H 2229/044; H01H 71/0264

(57) ABSTRACT

A Colored Circuit Breaker System for any existing and/or new circuit breaker panel structured and arranged to use specific, coded colors, at the point of manufacture, to identify individual circuits and breakers, easily identifying which breaker goes to which component.

### CROSS-REFERENCE TO RELATED APPLICATION

The present application is related to and claims priority from prior provisional application Ser. No. 62/582,663, filed Nov. 7, 2017 which application is incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### BACKGROUND OF THE INVENTION

The following includes information that may be useful in understanding the present invention(s). It is not an admission that any of the information provided herein is prior art, or material, to the presently described or claimed inventions, or that any publication or document that is specifically or implicitly referenced is prior art.

### 1. Field of the Invention

The present invention relates generally to the field of circuit breakers and more specifically relates to a colored circuit breaker system for any existing and/or new circuit breaker panel structured and arranged to use specific, coded colors, at the point of manufacture, to identify individual circuits and breakers, easily identifying which breaker goes to which component.

### 2. Description of the Related Art

Virtually every structure in the United States, whether home, hospital, office complex, or store, is electrically wired, with circuits controlled by breakers housed in a circuit breaker box. A circuit breaker is an automatically operated electrical switch designed to protect an electrical circuit from damage caused by excess current, typically resulting from an overload or short circuit. Its basic function is to interrupt current flow after a fault is detected. Unlike a fuse, which operates once and then must be replaced, a circuit breaker can be reset (either manually or automatically) to resume normal operation.

Circuit breakers are made in varying sizes, from small devices that protect low-current circuits or individual household appliance, up to large switchgear designed to protect high voltage circuits feeding an entire city. The generic function of a circuit breaker, RCD or a fuse, as an automatic means of removing power from a faulty system is often abbreviated as ADS (Automatic Disconnection of Supply).

In recent years, color-coded electrical conduit has become increasingly standard, as the color of the conduit identifies the circuits with which its wiring is associated—be it a fire or security alarm system, high-voltage wiring, low-voltage wiring, etc. But although the color-coding of conduit is increasingly standard, and likely to become incorporated into more building and electrical codes, the circuit breaker box itself, and the black breakers within it, have remained the same. Therefore, a need exists to complete the system by extending color-coding to the breaker box, and to the actual breakers within it.

Various attempts have been made to solve problems found in circuit breakers art. Among these are found in: U.S. Pat. No. 4,969,063 to Gary W. Scott et al.; U.S. Pub. No. 2002/0008628 to Leonard Sadjadi; and U.S. Pat. No. 4,633,240 to Raul Guim et al. This prior art is representative of circuit breakers comprising indicator means.

Ideally, a Colored Circuit Breaker System should be user-friendly and safe in-use and yet would operate reliably and be manufactured at a modest expense. Thus, a need exists for a Colored Circuit Breaker System for any existing and/or new circuit breaker panel structured and arranged to use specific, coded colors, at the point of manufacture, to identify individual circuits and breakers, easily identifying which breaker goes to which component and to avoid the above-mentioned problems.

### BRIEF SUMMARY OF THE INVENTION

In view of the foregoing disadvantages inherent in the known of circuit breaker art, the present invention provides a novel Colored Circuit Breaker System. The general purpose of the present invention, which will be described subsequently in greater detail is to provide a Colored Circuit Breaker System, a coloring system for any existing and/or new circuit breaker panel structured and arranged to use specific, coded colors, at the point of manufacture, to identify individual circuits and breakers, easily identifying which breaker goes to which component. Making it quick and easy to identify important circuits and working with the same color-code now widely used with electrical conduit (or chosen by the consumer) the Colored Circuit Breaker System should appeal strongly to electricians and household consumers, as well as to commercial and institutional establishments. Color coded stickers would also be offered to quickly identify existing breakers until the new Colored Circuit Breaker System is installed.

In a circuit breaker including a main body having two electrical conductors and a circuit breaking switch therebetween, the improvement comprising a main body is formed having a color to represent an area or system being supplied power thereto, such that when a problem occurs in said area or system the proper circuit breaker is more easily discernable.

The present invention holds significant improvements and serves as a Colored Circuit Breaker System. For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present invention, a Colored Circuit Breaker System, constructed and operative according to the teachings of the present invention.

FIG. 1 shows a perspective view illustrating an improved circuit breaker set of a Colored Circuit Breaker System according to an embodiment of the present invention.

FIG. 2A is a perspective view illustrating an improved circuit breaker system including a plurality of circuit breakers; a circuit breaker box; and plurality of electrical wires having at least one black colored electrical wire used supply power to and from at least one black colored circuit breaker according to an embodiment of the present invention of FIG. 1.

FIG. 2B is a perspective view illustrating an improved circuit breaker system including a plurality of circuit breakers; a circuit breaker box; and plurality of electrical wires having at least one white colored electrical wire used supply power to and from at least one black colored circuit breaker according to an embodiment of the present invention of FIG. 1.

The various embodiments of the present invention will hereinafter be described in conjunction with the appended drawings, wherein like designations denote like elements.

### DETAILED DESCRIPTION

As discussed above, embodiments of the present invention relate to a circuit breaker and more particularly to a Colored Circuit Breaker System, a coloring system for any existing and/or new circuit breaker panel structured and arranged to use specific, coded colors, at the point of manufacture, to identify individual circuits and breakers, easily identifying which breaker goes to which component. Making it quick and easy to identify important circuits and working with the same color-code now widely used with electrical conduit (or chosen by the consumer) the Colored Circuit Breaker System should appeal strongly to electricians and household consumers, as well as to commercial and institutional establishments. Color coded stickers would also be offered to quickly identify existing breakers until the new Colored Circuit Breaker System is installed.

Generally speaking, the Colored Circuit Breaker System will preferably complement the use of color-coded electrical conduit in wiring applications by extending the color-coding currently in use to the circuit breaker box as well as the individual breakers within it. Thus, the Colored Circuit Breaker System would be incorporated into the design and production of new breakers and boxes, with circuit breakers molded in the various identifying colors at the point of manufacture. As mentioned, color-coded, adhesive-backed stickers for existing individual breakers could also be included until the new Colored Circuit Breaker System could be installed.

At present, colored conduit or EMT (Electrical Metallic Tubing) is coded for use in the following manner:
Orange: Construction, Research Areas; Fiber Optic Systems; Auto Repair/Maintenance
Green: Hospital and Healthcare Areas; Nurse Call Stations; Critical Circuits
Purple: Specialty Wiring Systems; Security Systems
Red: Emergency Circuits: Fire Alarm and Security Systems
Yellow: High Voltage Wiring; Caution Areas; Special Equipment
Blue: Low Voltage Wiring; Data, Communications/Video; Network Security

The Black and White conduit are used in the color-coded system for their ability to blend inconspicuously in either dark or light places; with the color black being continued to be used for standard power circuits such as those that power lights and ordinary outlets.

The individual color-coded breakers would be color-coded as above. The color coding would not completely eliminate the need for individual labels, but, it would make it easier to identify in the case of breaker activation for ease of resetting. In addition, the above color coding is a guideline, however, as an option, it could be left up to the engineer, building maintenance personnel, or homeowner to decide what color breaker will go to which circuitry in their business or residence.

The purpose of the Colored Circuit Breaker System is to identify circuit breakers by color for ease of finding in any main panel with other circuits and the breaker box “would operate the same as existing boxes, while the breakers could easily be identified and changed as necessary. The Colored Circuit Breaker System would be code-compliant, and that as various jurisdictions—cities, towns, villages, counties—incorporate the color-coding into their building and electrical codes, homeowners and building owners would need to upgrade their systems to meet the codes, which would also apply to any new construction. This could assure the Colored Circuit Breaker System a large, ongoing market.

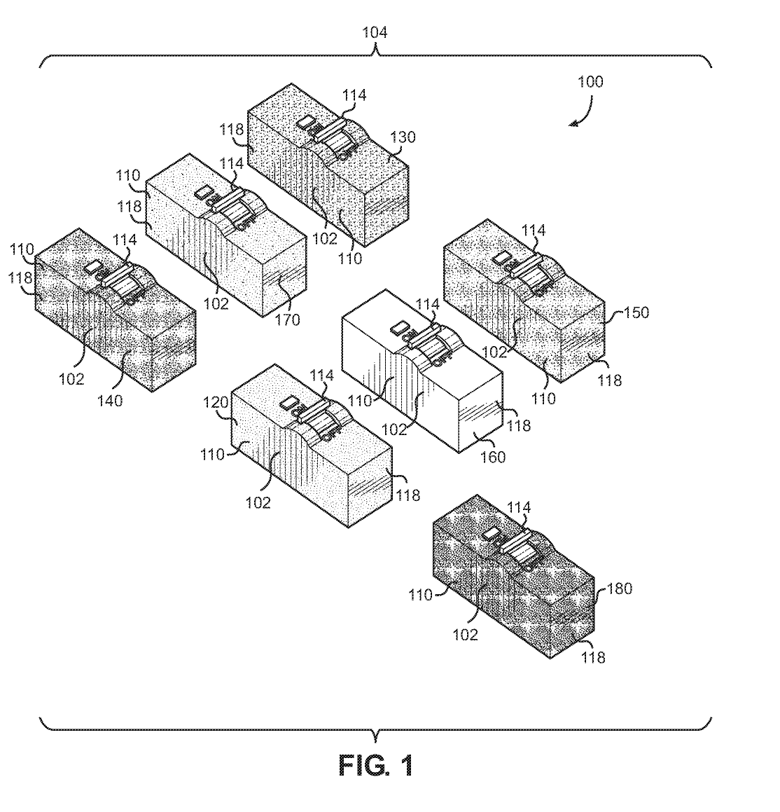

Referring to the drawings by numerals of reference there is shown in FIG. 1, a perspective view illustrating improved circuit breaker set 100 according to an embodiment of the present invention.

In circuit breaker 102 including main body 110 having two electrical conductors and circuit breaking switch 114 therebetween, improvement 100 comprising main body 110 is formed having color 118 to represent an area or system being supplied power thereto, such that when a problem occurs in the area or system the proper circuit breaker 102 is more easily discernable. Wherein main body 110 is injection molded plastic having said color impregnated therein.

Wherein color 118 is chosen from a list of colors consisting of: orange 120; green 130; purple 140; red 150; yellow 160; and blue 170. Wherein orange color 120 is used to represent an area to be provided electricity chosen from a list of areas to be provided electricity consisting of construction, research, fiber optics systems, and auto repair and maintenance. Wherein green color 130 is used to represent an area to be provided electricity chosen from a list of areas to be provided electricity consisting of a hospital, healthcare, nurse call stations, and critical circuits. Wherein purple color 140 is used to represent systems to be provided electricity chosen from a list of systems to be provided electricity consisting of specialty wiring systems, and security systems. Wherein red color 150 is used to represent systems to be provided electricity chosen from a list of systems to be provided electricity consisting of emergency circuits, and fire alarm and security systems. Wherein yellow color 160 is used to represent an area to be provided electricity chosen from a list of areas to be provided electricity consisting of high voltage wiring, caution, and special equipment. Wherein blue color 170 is used to represent systems to be provided electricity chosen from a list of systems to be provided electricity consisting of low voltage wiring, data, video communications, and network security.

Improved circuit breaker set 100 comprises: plurality of circuit breakers 104 including: at least one circuit breaker 102 formed having orange color 120; at least one circuit breaker 102 formed having green color 130; at least one circuit breaker 102 formed having purple color 140; at least one circuit breaker 102 formed having red color 150; at least one circuit breaker 102 formed having yellow color 160; and at least one circuit breaker 102 formed having blue color 170.

Wherein orange color 120 is used to represent an area to be provided electricity chosen from a list of areas to be provided electricity consisting of construction, research, fiber optics systems, and auto repair and maintenance. Wherein green color 130 is used to represent an area to be provided electricity chosen from a list of areas to be provided electricity consisting of a hospital, healthcare, nurse call stations, and critical circuits. Wherein purple color 140 is used to represent systems to be provided electricity chosen from a list of systems to be provided electricity consisting of specialty wiring systems, and security systems. Wherein red color 150 is used to represent systems to be provided electricity chosen from a list of systems to be provided electricity consisting of emergency circuits, and fire alarm and security systems. Wherein yellow color 160 is used to represent an area to be provided electricity chosen from a list of areas to be provided electricity consisting of high voltage wiring, caution, and special equipment. Wherein blue color 170 is used to represent systems to be provided electricity chosen from a list of systems to be provided electricity consisting of low voltage wiring, data, video communications, and network security. Improved circuit breaker set 100 further comprises at least one circuit breaker 102 formed having black color 180. Wherein black color 180 is used to represent standard power circuits to be provided electricity thereto.

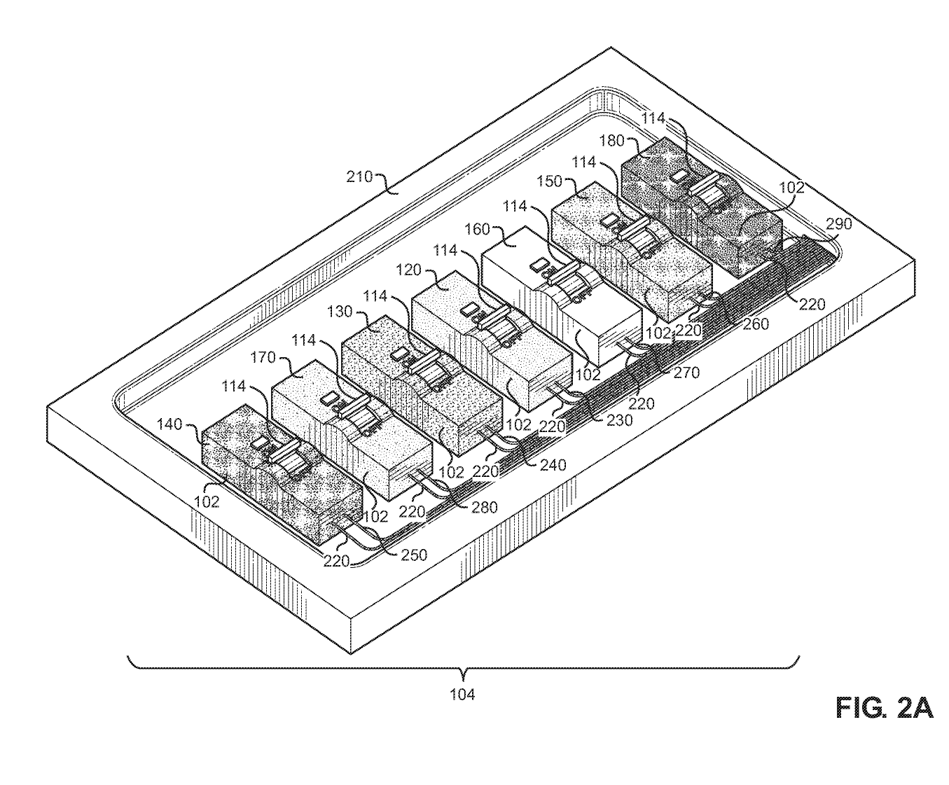

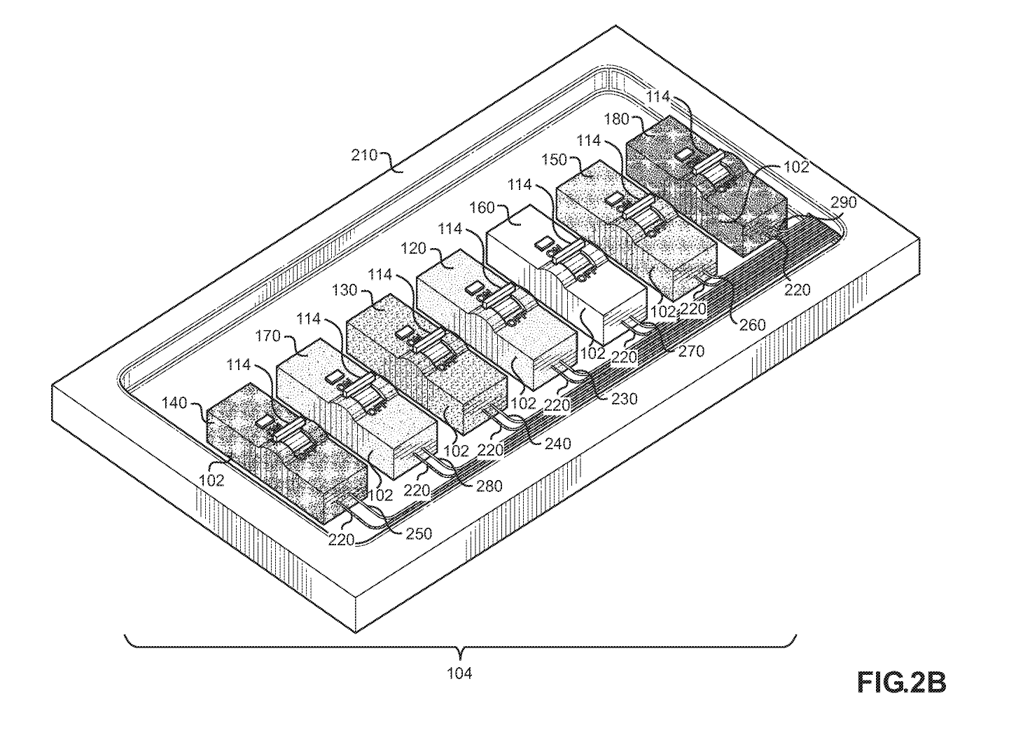

Referring now to FIG. 2, showing a perspective view illustrating improved circuit breaker system 200 according to an embodiment of the present invention.

Improved circuit breaker system 200 comprising: plurality of circuit breakers 104; circuit breaker box 210; and plurality of electrical wires 220. Plurality of circuit breakers 104 including: at least one circuit breaker 102 formed having orange color 120; at least one circuit breaker 102 formed having green color 130; at least one circuit breaker 102 formed having purple color 140; at least one circuit breaker 102 formed having red color 150; at least one circuit breaker 102 formed having yellow color 160; and at least one circuit breaker 102 formed having blue color 170.

Wherein orange color 120 is used to represent an area to be provided electricity chosen from a list of areas to be provided electricity consisting of construction, research, fiber optics systems, and auto repair and maintenance. Wherein green color 130 is used to represent an area to be provided electricity chosen from a list of areas to be provided electricity consisting of a hospital, healthcare, nurse call stations, and critical circuits. Wherein purple color 140 is used to represent systems to be provided electricity chosen from a list of systems to be provided electricity consisting of specialty wiring systems, and security systems. Wherein red color 150 is used to represent systems to be provided electricity chosen from a list of systems to be provided electricity consisting of emergency circuits, and fire alarm and security systems. Wherein yellow color 160 is used to represent an area to be provided electricity chosen from a list of areas to be provided electricity consisting of high voltage wiring, caution, and special equipment. Wherein blue color 170 is used to represent systems to be provided electricity chosen from a list of systems to be provided electricity consisting of low voltage wiring, data, video communications, and network security. Improved circuit breaker system 200 further comprises at least one circuit breaker 102 formed having black color 180. Wherein black color 180 is used to represent standard power circuits to be provided electricity thereto.

Wherein circuit breaker box 210 is adapted to securely and releasably hold plurality of circuit breakers 104 therein in a spaced relationship.

Plurality of electrical wires 220 comprises at least one electrical wire formed having orange color 230; at least one electrical wire formed having green color 240; at least one electrical wire formed having purple color 250; at least one electrical wire formed having red color 260; at least one electrical wire formed having yellow color 270; and at least one electrical wire formed having blue color 280.

Wherein at least one orange colored electrical wire 230 is used supply power to and from the at least one orange colored circuit breaker 120. Wherein at least one green colored electrical wire 240 is used supply power to and from at least one green colored circuit breaker 130. Wherein at least one purple colored electrical wire 250 is used supply power to and from at least one purple colored circuit breaker 140. Wherein at least one red colored electrical wire 260 is used supply power to and from at least one red colored circuit breaker 150. Wherein at least one yellow colored electrical wire 270 is used supply power to and from at least one yellow colored circuit breaker 160. Wherein said at least one blue colored electrical wire 280 is used supply power to and from at least one blue colored circuit breaker 170.

Improved circuit breaker system 200 further comprises at least one electrical wire formed having black color 290. Wherein said at least one black colored electrical wire 290 is used supply power to and from at least one black colored circuit breaker 180. Improved circuit breaker system 100 further comprises at least one electrical wire formed having white color 294 as shown in FIG. 2B. Wherein at least one white colored electrical wire 294 is used supply power to and from said at least one black colored circuit breaker 180.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is:

1. In a circuit breaker including a main body having two electrical conductors and a circuit breaking switch therebetween, the improvement comprising:
wherein said main body is formed having a color to represent an area or system being supplied power thereto, such that when a problem occurs in said area or system the proper circuit breaker is more easily discernable.

2. The improved circuit breaker of claim 1, wherein said main body is injection molded plastic having said color impregnated therein.

3. The improved circuit breaker of claim 1, wherein said color is chosen from a list of colors consisting of:
orange;
wherein said orange color is used to represent an area to be provided electricity chosen from a list of areas to be provided electricity consisting of construction, research, fiber optics systems, and auto repair and maintenance;
green;
wherein said green color is used to represent an area to be provided electricity chosen from a list of areas to be provided electricity consisting of a hospital, healthcare, nurse call stations, and critical circuits;
purple;
wherein said purple color is used to represent systems to be provided electricity chosen from a list of systems to be provided electricity consisting of specialty wiring systems, and security systems;
red;
wherein said red color is used to represent systems to be provided electricity chosen from a list of systems to be provided electricity consisting of emergency circuits, and fire alarm and security systems;
yellow;
wherein said yellow color is used to represent an area to be provided electricity chosen from a list of areas to be provided electricity consisting of high voltage wiring, caution, and special equipment; and
blue;
wherein said blue color is used to represent systems to be provided electricity chosen from a list of systems to be provided electricity consisting of low voltage wiring, data, video communications, and network security.

4. An improved circuit breaker set comprising:
a plurality of circuit breakers including:
at least one circuit breaker formed having an orange color;
wherein said orange color is used to represent an area to be provided electricity chosen from a list of areas to be provided electricity consisting of construction, research, fiber optics systems, and auto repair and maintenance;
at least one circuit breaker formed having an green color;
wherein said green color is used to represent an area to be provided electricity chosen from a list of areas to be provided electricity consisting of a hospital, healthcare, nurse call stations, and critical circuits;
at least one circuit breaker formed having an purple color;
wherein said purple color is used to represent systems to be provided electricity chosen from a list of systems to be provided electricity consisting of specialty wiring systems, and security systems;
at least one circuit breaker formed having an red color;
wherein said red color is used to represent systems to be provided electricity chosen from a list of systems to be provided electricity consisting of emergency circuits, and fire alarm and security systems;
at least one circuit breaker formed having an yellow color;
wherein said yellow color is used to represent an area to be provided electricity chosen from a list of areas to be provided electricity consisting of high voltage wiring, caution, and special equipment; and
at least one circuit breaker formed having an blue color;
wherein said blue color is used to represent systems to be provided electricity chosen from a list of systems to be provided electricity consisting of low voltage wiring, data, video communications, and network security.

5. An improved circuit breaker set of claim 4, further comprising:
at least one circuit breaker formed having a black color;
wherein said black color is used to represent standard power circuits to be provided electricity thereto.

6. An improved circuit breaker system comprising:
a plurality of circuit breakers including:
at least one circuit breaker formed having an orange color;
wherein said orange color is used to represent an area to be provided electricity chosen from a list of areas to be provided electricity consisting of construction, research, fiber optics systems, and auto repair and maintenance;
at least one circuit breaker formed having an green color;
wherein said green color is used to represent an area to be provided electricity chosen from a list of areas to be provided electricity consisting of a hospital, healthcare, nurse call stations, and critical circuits;
at least one circuit breaker formed having an purple color;
wherein said purple color is used to represent systems to be provided electricity chosen from a list of systems to be provided electricity consisting of specialty wiring systems, and security systems;
at least one circuit breaker formed having an red color;
wherein said red color is used to represent systems to be provided electricity chosen from a list of systems to be provided electricity consisting of emergency circuits, and fire alarm and security systems;
at least one circuit breaker formed having an yellow color;
wherein said yellow color is used to represent an area to be provided electricity chosen from a list of areas to be provided electricity consisting of high voltage wiring, caution, and special equipment; and
at least one circuit breaker formed having an blue color;
wherein said blue color is used to represent systems to be provided electricity chosen from a list of systems to be provided electricity consisting of low voltage wiring, data, video communications, and network security;
a circuit breaker box;
wherein said circuit breaker box is adapted to securely and releasably hold said plurality of circuit breakers therein in a spaced relationship; and
a plurality of electrical wires comprising:
at least one electrical wire formed having an orange color;
wherein said at least one orange colored electrical wire is used supply power to and from said at least one orange colored circuit breaker;
at least one electrical wire formed having an green color;
wherein said at least one green colored electrical wire is used supply power to and from said at least one green colored circuit breaker;
at least one electrical wire formed having an purple color;
wherein said at least one purple colored electrical wire is used supply power to and from said at least one purple colored circuit breaker;
at least one electrical wire formed having an red color;
wherein said at least one red colored electrical wire is used supply power to and from said at least one red colored circuit breaker;
at least one electrical wire formed having an yellow color;
wherein said at least one yellow colored electrical wire is used supply power to and from said at least one yellow colored circuit breaker; and
at least one electrical wire formed having an blue color;
wherein said at least one blue colored electrical wire is used supply power to and from said at least one blue colored circuit breaker.

7. An improved circuit breaker system of claim 6, further comprising:
at least one circuit breaker formed having a black color;
wherein said black color is used to represent standard power circuits to be provided electricity thereto.

8. An improved circuit breaker system of claim 7, further comprising:
at least one electrical wire formed having an black color;
wherein said at least one black colored electrical wire is used supply power to and from said at least one black colored circuit breaker.

9. An improved circuit breaker system of claim 6, further comprising:
at least one electrical wire formed having an white color;
wherein said at least one white colored electrical wire is used supply power to and from said at least one black colored circuit breaker.
